(19) United States
(12) Patent Application Publication
(10) Pub. No.: US 2014/0061271 A1
(43) Pub. Date: Mar. 6, 2014

(54) BICYCLE ACCESSORY MOUNT

(71) Applicant: TATE LABS, INC., Novato, CA (US)

(72) Inventor: Benjamin Duncan Tate, Novato, CA (US)

(73) Assignee: Tate Labs, Inc., Novato, CA (US)

(21) Appl. No.: 13/793,146

(22) Filed: Mar. 11, 2013

Related U.S. Application Data
(60) Provisional application No. 61/694,465, filed on Aug. 29, 2012.

(51) Int. Cl. B60R 11/00

(52) U.S. Cl. CPC B60R 11/00
USPC 224/545

(57) ABSTRACT

A bicycle accessory mount includes an engagement portion, a support portion, and an attachment portion. The engagement portion frictionally engages with a cylindrical component of a bicycle. The attachment portion attaches an accessory to the attachment mount. The support portion couples the engagement portion to the attachment portion and positions the accessory relative to the rider.

This application claims priority under 35 USC 199 to U.S. provisional application Ser. No. 61/694,465 filed Aug. 29, 2012, which is incorporated herein by reference.

### SUMMARY

An accessory mount for positioning an accessory on a bicycle comprises an engagement portion defining an engagement surface adapted to frictionally engage with a cylindrical component of the bicycle, an attachment portion having a rotational attachment surface to fixedly attach the accessory to the accessory mount, and a support portion that couples the engagement portion to the attachment portion.

An accessory mount for positioning an accessory on a bicycle comprises an engagement portion defining an engagement surface adapted to frictionally engage with a cylindrical component of the bicycle, an attachment portion configured to fixedly attach the accessory to the accessory mount, and a support portion that couples the engagement portion to the attachment portion, wherein the support portion comprises an extension portion that extends from the engagement portion along a plane perpendicular to the axis of the cylindrical component of the bicycle, and a positioning portion that locates the rotational attachment surface at an offset to the extension portion.

A rotational attachment component of an accessory mount for positioning an accessory on a bicycle comprises a support portion, wherein the support portion comprises a coupling portion configured to couple the support portion to the accessory mount and a plurality of extension portions that extend from the coupling portion, and a plurality of ridges located on the extension portions and configured to fixedly attach the accessory to the accessory mount.

### BRIEF DESCRIPTION OF THE FIGURES

The above and other features of the present disclosure, its nature and various advantages will be more apparent upon consideration of the following detailed description, taken in conjunction with the accompanying drawings in which:

FIG. 1 shows an illustrative accessory mount attached to a cylindrical component of a bicycle in accordance with some embodiments of the present disclosure;

FIG. 2 shows a top view of an illustrative accessory mount in accordance with some embodiments of the present disclosure;

FIG. 3 shows a section view of an illustrative accessory mount in accordance with some embodiments of the present disclosure;

FIG. 4 shows a top view of an illustrative accessory mount in accordance with some embodiments of the present disclosure; and

FIG. 5 shows a top view, a section view, and a bottom view of an illustrative rotational attachment component in accordance with some embodiments of the present disclosure.

### DETAILED DESCRIPTION OF THE FIGURES

Bicycles are used for numerous applications. Exemplary bicycle types include road bicycles, touring bicycles, time trial bicycles, triathlon bicycles, BMX bicycles, Randonneur bicycles, Audax bicycles, hybrid bicycles, utility bicycles, mountain bicycles, freight bicycles, messenger bicycles, bicycle taxis, and motorized bicycles. Bicycles may be used for any suitable application, such as recreation, transportation, commuting, deliveries, taxi services, and commercial applications.

A bicycle rider may desire to attach accessories to the bicycle in a manner suitable for use of the accessories. Although any suitable accessories may be used by a rider, exemplary accessories include bicycle computers, speedometers, GPS devices, music players, telephones, triathlon watches, smart phones, mobile transmitters, Wi-Fi or other wireless communication devices, touch screen devices, any other suitable accessories, or any combination thereof. These accessories may be used to improve the experience of the rider for purposes such as recreation, transportation, commuting, deliveries, taxi services, and commercial applications.

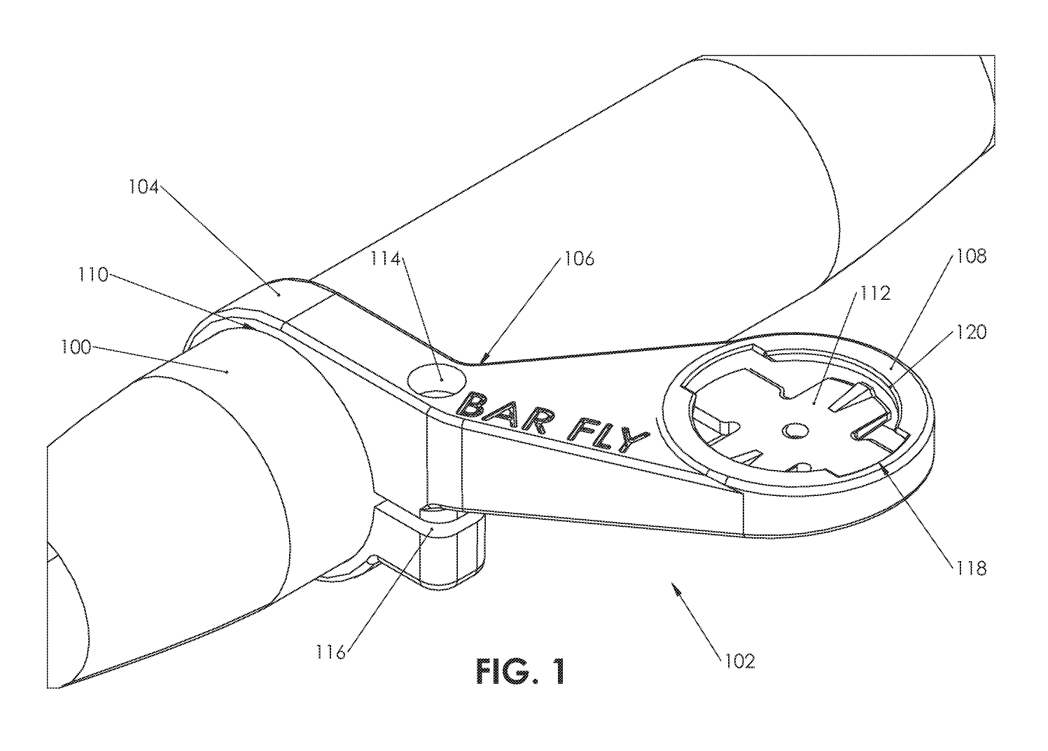

FIG. 1 depicts an accessory mount for a bicycle in accordance with some embodiments of the present disclosure. As will be described herein, accessories may be fixedly attached to the accessory mount, and the accessory mount may engage with the bicycle. Although the accessory mount will be described herein as engaging with a cylindrical component of the bicycle, it will be understood that the accessory mount may be configured in any suitable manner to engage with non-cylindrical bicycle components.

An exemplary bicycle may include a number of cylindrical components, such as the bicycle frame, seat post, and handlebars. Although an accessory mount may be configured to attach to any suitable bicycle component, in an exemplary embodiment, the accessory mount may be configured to attach to the bicycle handlebars in a manner that positions the accessory for ease of viewing and/or access by the rider. In exemplary embodiments, an accessory mount that engages with a cylindrical component may be located by the user at any suitable location of the bicycle wherein the cylindrical component has a diameter that engages with a diameter associated with an engagement surface of an engagement portion of the accessory mount, as described herein. For example, in some embodiments, components such as handlebars (e.g., drop bars, track bars, ergo bars, Randonneur bars, drop-in bars, riser bars, upright bars, Pourteur bars, touring bars, trekking bars, triathlon bars, aerobars, pursuit bars, BMX bars, cruiser bars, moustache bars, ape hanger bars, recumbent bars, or Whatton bars) may include generally cylindrical portions, and exemplary bicycles may be configured to accept any handlebars having a standard handlebar diameter (e.g., 31.8 mm diameter handlebars, 22-23 mm diameter aero bars, or any other suitable standardized dimensions).

Referring to FIG. 1, an accessory mount 102 may be engaged with a cylindrical component 100. The accessory mount may include an engagement portion 104, a support portion 106, and an attachment portion 108. Although a single engagement portion 104 is depicted, it will be understood that any suitable number of engagement portions 104 may be used to engage the accessory mount 102 to the cylindrical component 100. For example, in an exemplary embodiment (not depicted), two or more engagement portions 104 may be coupled to support portion 106 and engaged with the cylindrical component 100. Although a single attachment portion 108 is depicted, it will be understood that any suitable number of attachment portions 108 may be used to attach accessories (not depicted) to the accessory mount 102. For example, in an exemplary embodiment (not depicted), two or more attachment portions 108 may be coupled to support portion 106 for attachment of two or more accessories to accessory mount 102. In another embodiment, a plurality of different types of attachment portions 108 (e.g., utilizing quarter turn mount, eighth turn mount, rotational mount, screw mount, sliding mount, or any other suitable attachment mechanism) may be coupled to support portion 106 for attachment of two or more accessories to accessory mount 102.

In an exemplary embodiment, engagement portion 104, support portion 106, and attachment portion 108 may be a unitary component as depicted in FIG. 1. However, it will be understood that each of engagement portion 104, support portion 106, and attachment portion 108 may constructed of two or more components in any suitable manner. It will be understood that accessory mount 102 may include any additional suitable portions or components (not depicted), and that each of engagement portion 104 and attachment portion 108 may be coupled to support portion 106 in any suitable manner, including with additional intervening portions or components.

Accessory mount 102 may be constructed of any suitable material or combination of materials, including metals (e.g., aluminum), polymers, composites, ceramics, any other suitable material, or any combination thereof. In an exemplary embodiment, accessory mount 102 may be constructed of an acetal polymer such as Delrin. Although it will be understood that any suitable material may be selected for any suitable application, an acetal polymer such as Delrin may provide a flexibility that allows an opening 116 of engagement portion 104 to be expanded to be flexibly pulled over cylindrical component 100, may have properties that permit suitable frictional engagement with cylindrical component 100, and may provide stability and robustness for supporting an accessory (not depicted) upon attachment portion 108.

Engagement portion 104 may provide for frictional engagement with cylindrical component 100. Engagement portion 104 may include an interior engagement surface 110 that frictionally engages with cylindrical component 100. The width of engagement portion 104 may define a surface area of engagement surface 110 that frictionally engages with cylindrical component 100, and may be any suitable width to provide a degree of friction suitable for a particular application and a desired degree of frictional engagement. Although engagement portion 104 may have any suitable thickness, in an exemplary embodiment, a thickness may be suitable to allow engagement portion 104 to be flexibly pulled over cylindrical component 100.

Support portion 106 may couple engagement portion 104 to attachment portion 108. Support portion 106 may be constructed in any suitable manner to accommodate any suitable engagement portion 104, plurality of engagement portions 104, attachment portion 108, plurality of attachment portions 108, any other suitable components or attachments, or any combination thereof. In an exemplary embodiment as depicted herein a single engagement portion 104 may be coupled to a single attachment portion 108.

Although the engagement portion 104, support portion 106, and attachment portion 108 may be configured in any suitable manner to define any suitable relative position of attachment portion 108 to engagement portion 104, in an exemplary embodiment, the attachment portion 108 may be positioned such that a rotational attachment surface 112 is on a plane that is substantially tangentially aligned with the cylindrical component 100. For example, if accessory mount 102 is attached to bicycle handlebars, an accessory attached to accessory mount 102 may be located in front of the bicycle handlebars for ease of viewing and/or access. In other exemplary embodiments, attachment portion 108 may be positioned in a manner such that rotational attachment surface 112 is on a plane that is substantially perpendicular to the axis of cylindrical component 100, in a manner such that rotational attachment surface 112 is on a plane that is substantially aligned with the axis of cylindrical component 100, or in any other suitable manner that defines a desired relationship between a plane corresponding to rotational attachment surface 112 and cylindrical component 100.

In the exemplary embodiment depicted in FIG. 1, support portion 106 may include an extension portion that extends along a plane perpendicular to the axis of cylindrical component 100 and a positioning portion that locates rotational attachment surface 112 relative to the extension portion. In an exemplary embodiment, the positioning portion of support portion 106 may locate the rotational attachment surface 112 at an offset from the extension portion as depicted in FIG. 1. In an exemplary embodiment where the accessory mount is located adjacent to a bicycle stem component, the offset may allow for a centered location of the accessory that is attached to attachment portion 108. Although support portion 106 may have any suitable relative shape, in an exemplary embodiment, support portion 106 may be tapered as depicted in FIG. 1. Although support portion 106 may be constructed in any suitable manner (e.g., solid, partially hollowed, recessed, etc.), in an exemplary embodiment, support portion 106 may be recessed with a suitable wall thickness, for example, along the surface opposite rotational attachment surface 112.

An engagement component (not depicted) may be utilized to fix, lock, and/or adjust the engagement of engagement surface 110 to cylindrical component 100. Exemplary engagement components may include one or more of bolts, screws, locks, levers, latches, magnets, clamps, adhesives, any other suitable engagement component, or any combination thereof. In an exemplary embodiment, accessory mount 102 may include an engagement cavity 114 that allows for a bolt to be used as an engagement component. Engagement cavity 114 may be recessed to allow a bolt to be fully recessed within accessory mount 102. Although accessory mount 102 may engage the threads of the bolt in any suitable manner, in an exemplary embodiment, a threaded insert (not depicted) may be inserted (e.g., with a press fit, adhesive, or in any other suitable manner) into accessory mount 102, such that an interior surface of the insert may engage the threads of the bolt. The tightening of the bolt may close opening 116 of accessory mount 102, as well as adjusting the frictional engagement of the engagement surface 110 of engagement portion 104 to cylindrical component 100.

Attachment portion 108 may be constructed in any suitable manner to fixedly attach one or more accessories to accessory mount 102, such as rotational attachment, slidable attachment, attachment via screws, attachment via bolts, attachment via locks, attachment with tabs, any other suitable attachment mechanism, or any combination thereof. Although some accessories may include an interface that is compatible with attachment portion 108 of accessory mount 102, in some embodiments an accessory interface (not depicted) may be provided for accessories. An exemplary accessory interface may include a compatible portion to attach to attachment portion 108, and may attach to the accessory in any suitable manner, such as a sleeve, an adapter for an attachment component of the accessory, screws, bolts, clamps, adhesives, magnets, any other suitable attachment mechanism, or any combination thereof. In an exemplary embodiment, a sleeve may substantially encase a smart phone, and may include a compatible portion to attach to attachment portion 108. An exemplary smart phone can thus run any suitable program or “app” utilizing any suitable hardware and software of the smart phone.

Although rotational attachment may be implemented in any suitable manner, in an exemplary embodiment, attachment portion 108 may provide for rotational attachment of accessories to attachment mount 102. Attachment portion 108 may include one or more attachment slots 118, a retaining lip 120, and attachment surface 112. A compatible portion of an accessory or accessory interface may include one or more retaining tabs that slidably fit within attachment slots 118, and may have an appropriate clearance to be seated on attachment surface 112 under retaining lip 120. In an embodiment, the accessory or accessory interface may be rotated until the one or more ridges of attachment surface 112 engage with a corresponding one or more recesses or detents of the compatible portion of the accessory or accessory interface. The one or more ridges of attachment surface 112 may prevent rotational movement of the accessory or accessory interface during use, and may apply a corresponding pressure between the retaining lip of attachment portion 108 and the retaining tab of the accessory or accessory interface. It will be also be understood that, in some embodiments, attachment portion 108 may attach to the accessory or accessory interface based on a relationship with the retaining tabs of the accessory or accessory interface, for example, by providing one or more tabs or ridges that engage with a side surface of the retaining tabs. It will also be understood that any suitable combination of attachment methods may be utilized.

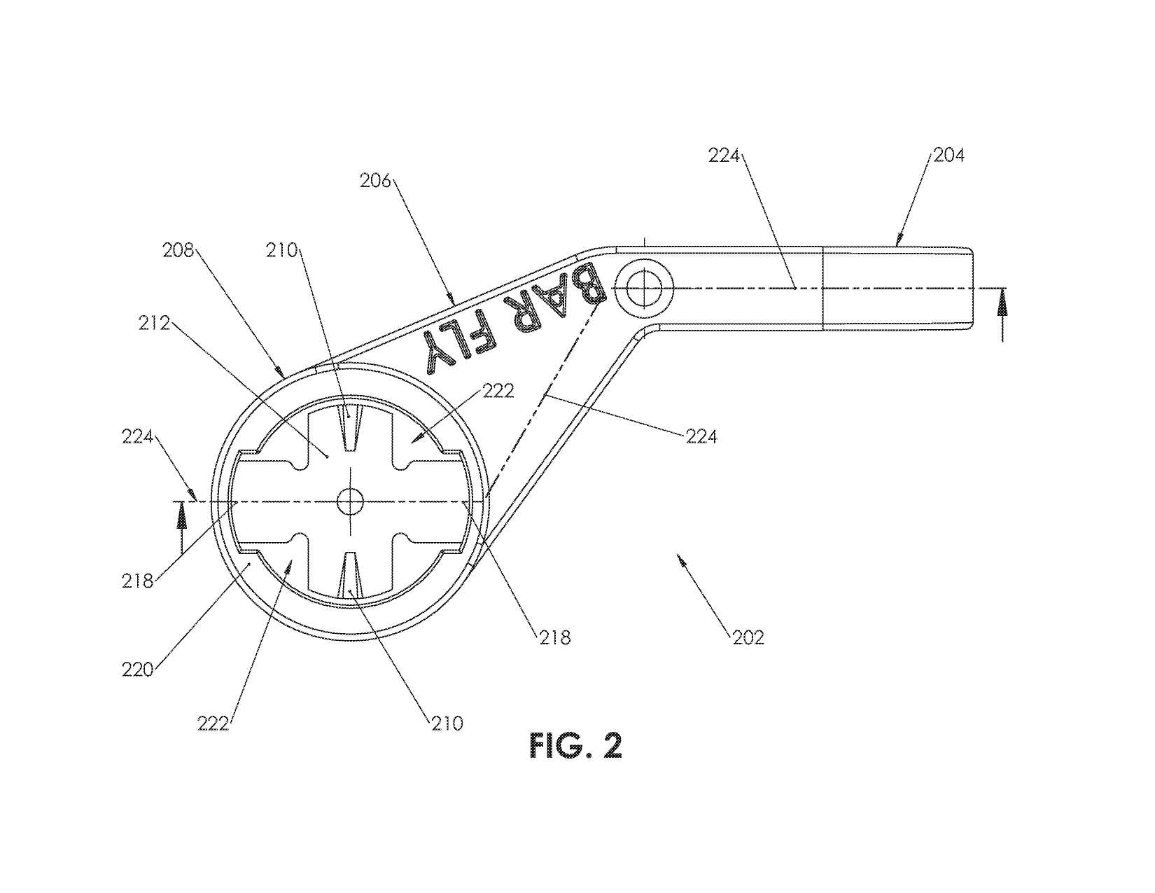

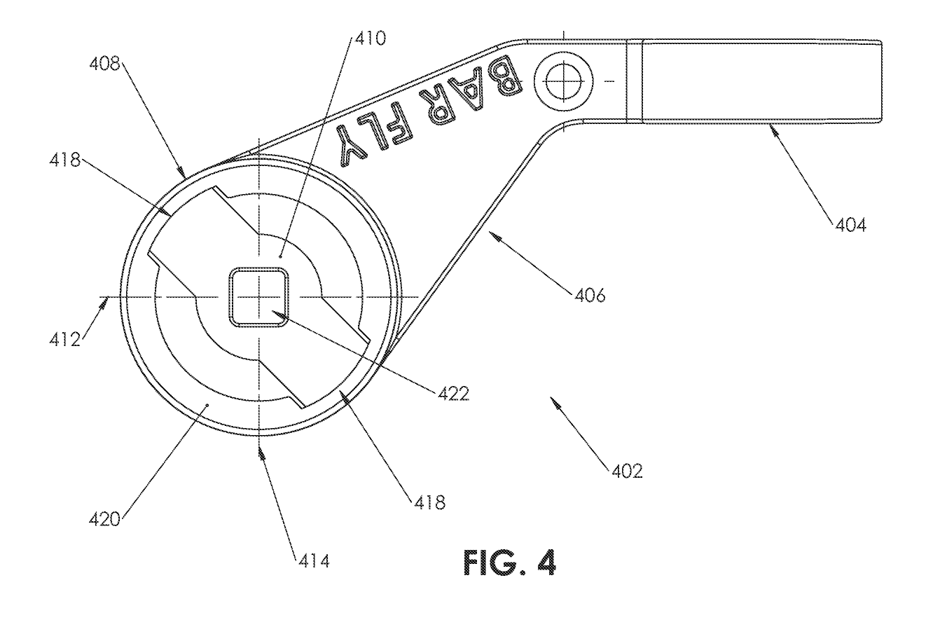

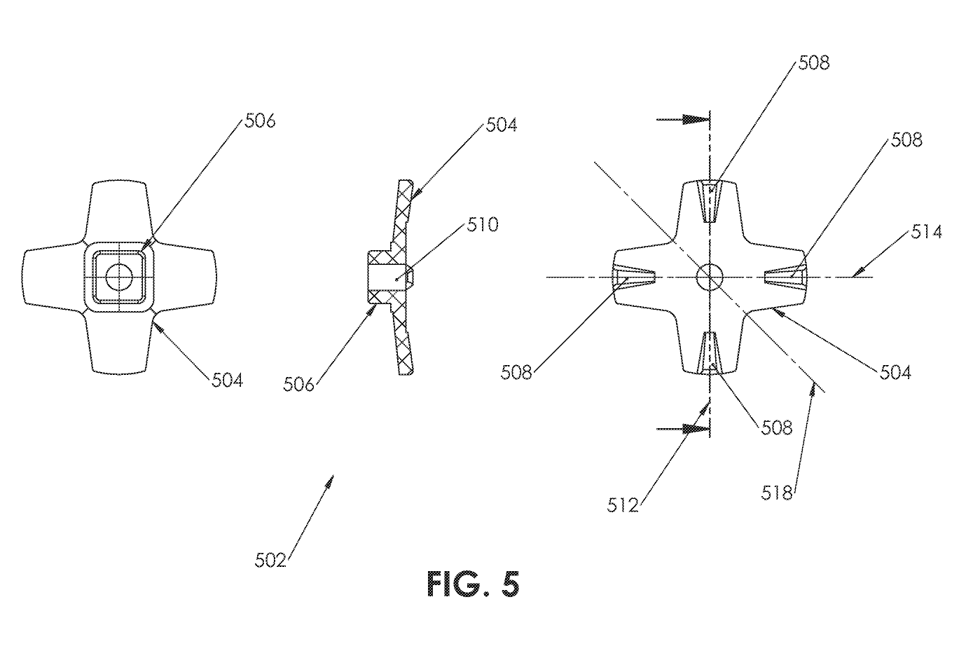

FIG. 2 depicts a top view of an illustrative accessory mount in accordance with some embodiments of the present disclosure. Accessory mount 202 may include engagement portion 204, support portion 206, and attachment portion 208. FIG. 2 may depict an exemplary embodiment of attachment portion 208, which may be described as a quarter turn rotational attachment component. It will be understood that any suitable attachment portion may be implemented as attachment portion 208 (e.g., an eighth turn attachment portion as described with respect to FIGS. 4-5). Although attachment portion 208 may include any suitable components, in an exemplary embodiment, attachment portion 208 may include rotational attachment surface 212, ridges 210 located on rotational attachment surface 212, retaining lip 220, and attachment slots 218.

Although the components of attachment portion may be configured in any suitable manner, in an exemplary embodiment, two attachment slots 218 are arranged at opposite ends of retaining lip 220 at 90° angles to ridges 210. Although attachment portion 208 is depicted as a single component attached in FIG. 2, it will be understood that attachment portion 208 may be constructed in any suitable manner. For example, attachment surface 212 may be part of a component that can attach within attachment portion 208 at a plurality of orientations in a manner to allow ridges 210 to be positioned at a plurality of different orientations in a manner that allows for accessories to be positioned at a plurality of angles relative to a rider.

Although rotational attachment surface 212 may be coupled to other components of attachment portion 210 in any suitable manner, in an exemplary embodiment, rotational attachment surface 212 may be coupled to other components of attachment portion 208 at locations that correspond to attachment slots 218. Rotational attachment surface 212 may define attachment gaps 222, which in some embodiments may provide additional points of contact with a compatible portion (e.g., retaining tabs) of an accessory or accessory interface. Although two attachment gaps are depicted, and the attachment gaps are depicted in a particular arrangement, it will be understood that any quantity of attachment gaps may be arranged in any suitable manner. Ridges 210 may protrude from rotational attachment surface 212. Although any number of ridges 210 may be arranged in any suitable manner on rotational attachment surface 212, in an exemplary embodiment, two ridges 210 may be arranged perpendicular to attachment slots 218.

In an exemplary embodiment, a compatible portion of an accessory or accessory interface is inserted into attachment slots 218, and rotated in a manner such that the retaining tab of the compatible portion of the accessory engages with retaining lip 220 of attachment portion 208. The compatible portion of the accessory or accessory interface may include a recess or detent that may engage with ridges 210 of attachment portion 208 to fixedly attach the accessory or accessory interface. In an embodiment the recess or detent may be located to engage the ridges when the accessory or accessory interface is turned 90° in either the clockwise or counter-clockwise direction (i.e., a quarter turn).

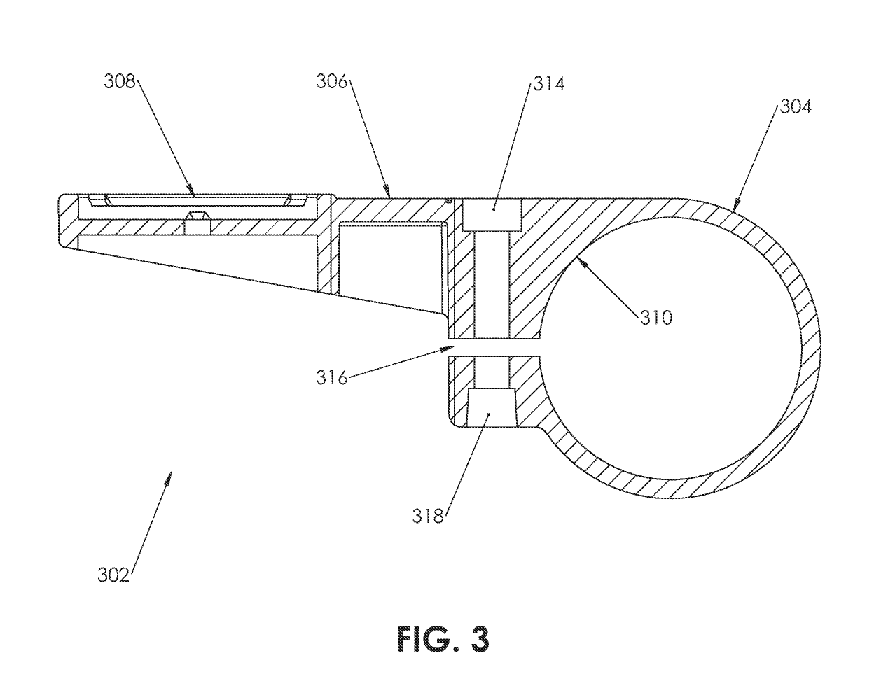

FIG. 3 shows a section view of an illustrative accessory mount in accordance with some embodiments of the present disclosure. The depicted section view corresponds to section line 224 of FIG. 2. Accessory mount 302 may include engagement portion 304, support portion 306, and attachment portion 308. In some embodiments, engagement portion 304 may engage with a component of a bicycle in any suitable manner, such as bolts, screws, locks, levers, latches, magnets, clamps, adhesives, or any combination thereof. As is depicted in FIG. 3, and in an exemplary embodiment, engagement portion 304 may define an engagement surface 310 that frictionally engages with a cylindrical component of a bicycle. Engagement surface 310 may have any suitable shape to frictionally engage with a surface such as a cylindrical surface of a bicycle, and in some embodiments may only partially engage with the component of the bicycle. In an exemplary embodiment, engagement surface 310 may define a circular engagement surface.

Although engagement surface 310 may be engaged with the cylindrical component of the bicycle in any suitable manner, in an exemplary embodiment, an opening 316 may allow accessory mount 302 to be flexibly pulled over the cylindrical component of the bicycle to engage with engagement surface 310. In an exemplary embodiment, opening 316 may be configured to be closed when a single engagement component (not depicted) fixes, locks, and/or adjusts engagement portion 304 of the accessory mount 302. Although an embodiment relating to a flexible accessory mount 302 and an opening 316 is described herein, it will be understood that an engagement portion may also include a plurality of components that may be coupled together without flexibly pulling the accessory mount over the cylindrical component of the bicycle.

Although an engagement component may be implemented in any suitable manner as described herein, in an exemplary embodiment, an engagement cavity 314 may define a cavity for a bolt (not depicted) and threaded insert (not depicted) to provide for the engagement and adjustment of engagement surface 310 relative to the cylindrical component. In an exemplary embodiment, the threaded insert may be located within a first portion 318 of the engagement cavity 314.

FIG. 4 shows a top view of an illustrative accessory mount in accordance with some embodiments of the present disclosure. Accessory mount 402 may include engagement portion 404, support portion 406, and attachment portion 408. The accessory mount depicted in FIG. 4 may be similar to the accessory mount depicted in described an FIGS. 1-3, with a different relative positioning of the attachment portion relative to the cylindrical component of the bicycle (e.g., based on the positioning portion of support portion 406) and having an attachment portion 408 that includes a two-part attachment component (e.g., an eighth turn attachment component) as described with respect to FIGS. 4-5.

An attachment portion 408 may include a seating portion 410, attachment slots 418, retaining lip 420, and a rotational attachment component 502 (depicted and described with respect to FIG. 5) that may be fastened to seating portion 410. Seating portion 410 may support rotational attachment component 502 and provide a fastening surface for rotational attachment component 502. Although rotational attachment component 502 may be fastened to seating portion 410 in any suitable manner, in an exemplary embodiment, seating portion 410 may define a though hole 422 that interfaces with a fastening portion of rotational attachment component 502 as described herein. In some embodiments, seating portion 410 may be configured in a manner to allow rotational attachment component 502 to be positioned at a plurality of rotational orientations.

Although an accessory may attach to the attachment portion 408 in any suitable manner, in an exemplary embodiment, attachment portion 408 may implement an eighth turn rotational attachment component. An eighth turn rotational attachment component may allow accessories to be oriented in at least four orientations, each corresponding to a set of two ridges. When the rotational attachment component of FIG. 5 is fastened to seating portion 410, a set of two ridges may be aligned along each of planes 412 and 414. This arrangement may provide for four orientations of the accessory or accessory interface, one in each direction of each of planes 412 and 414.

Although attachment slots 418 may be oriented in any suitable manner in comparison to planes 412 and 414, in an exemplary embodiment, attachment slots 418 may be oriented at a 45° angle to planes 412 and 414. In an exemplary embodiment, the recesses or detents of an accessory may be located on a bottom surface of the attachment tabs of the accessory. If the recesses or detents of the accessory are aligned with the retaining tabs of the accessory, an eighth turn (or 45° turn) of an accessory that is inserted into attachment portion 408 through attachment slots 418 in the clockwise direction may align the retaining tabs of the accessory (and thus the recesses or detents) with the ridges on plane 414, while an eighth turn (or 45° turn) of an accessory in the counter-clockwise direction may align the retaining tabs of the accessory (and thus the recesses or detents) with ridges on plane 412. In this manner, the accessory may be rotated to any of the four possible orientations by a rider in order to obtain the desired orientation of the accessory.

FIG. 5 shows a top view, a section view, and a bottom view of an illustrative rotational attachment component 502 in accordance with some embodiments of the present disclosure. Rotational attachment component 502 may include support surface 504, fastening portion 506, and ridges 508. Although support surface 504 may be configured in any suitable manner, in an exemplary embodiment, support surface 504 may include a coupling portion coupled to fastening portion 506 and a plurality of extensions associated with ridges 508. Although the extensions may be configured in any suitable manner, in an exemplary embodiment, an extension may be associated with each of ridges 508. In an embodiment, a coupling portion of support surface 504 may include a through hole 510.

Fastening portion 506 may be configured to fasten rotational attachment component 502 to seating portion 410 of accessory mount 402. Although rotational attachment component 502 may be attached to seating portion 410 in any suitable manner (e.g., bolts, screws, locks, levers, latches, magnets, clamps, adhesives, any other suitable attachment method, or any combination thereof), in an exemplary embodiment, fastening portion may provide for a press fit with through hole 422 of seating portion 410. In an embodiment, a tab (not depicted) may be located on fastening portion 506 to fixedly attach to an opposite surface of seating portion 410 when fastening portion is inserted into through hole 422.

Although any suitable number of ridges 508 may be included on rotational attachment component 502, and ridges 508 may be arranged on support surface portion 504 in any suitable manner, in an exemplary embodiment, four ridges 508 may be located at 90° angles on planes 512 and 514 (which may be associated with planes 412 and 414, respectively) in a manner that implements an eight turn rotational attachment component. A plane 518 may correspond to attachment slots 418 depicted in FIG. 4.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. An accessory mount for positioning an accessory on a bicycle, comprising:
an engagement portion defining an engagement surface adapted to frictionally engage with a cylindrical component of the bicycle;
an attachment portion having a rotational attachment surface to fixedly attach the accessory to the accessory mount; and
a support portion that couples the engagement portion to the attachment portion.

2. The apparatus of claim 1, wherein the attachment portion comprises a quarter turn rotational attachment component.

3. The apparatus of claim 1, further comprising an eighth turn rotational attachment component coupled to the rotational attachment surface.

4. The apparatus of claim 1, further comprising an engagement component adapted to proportionally adjust the degree of frictional engagement between the engagement surface and the cylindrical component of the bicycle.

5. The apparatus of claim 1, wherein the engagement portion includes a threaded portion.

6. The apparatus of claim 1, further comprising a threaded insert coupled to the engagement portion.

7. The apparatus of claim 1, wherein the engagement portion, attachment portion, and support portion consist of a unitary component.

8. The apparatus of claim 1, wherein the support portion comprises:
an extension portion that extends from the engagement portion along a plane perpendicular to the axis of the cylindrical component of the bicycle; and
a positioning portion that locates the rotational attachment surface relative to the extension portion.

9. The apparatus of claim 8, wherein the positioning portion locates the rotational attachment surface at an offset to the extension portion.

10. The apparatus of claim 1, wherein the rotational attachment surface is on a plane that is substantially tangentially aligned with the cylindrical component of the bicycle.

11. An accessory mount for positioning an accessory on a bicycle, comprising:
an engagement portion defining an engagement surface adapted to frictionally engage with a cylindrical component of the bicycle;
an attachment portion configured to fixedly attach the accessory to the accessory mount; and
a support portion that couples the engagement portion to the attachment portion, wherein the support portion comprises:
an extension portion that extends from the engagement portion along a plane perpendicular to the axis of the cylindrical component of the bicycle; and
a positioning portion that locates the rotational attachment surface at an offset to the extension portion.

12. The apparatus of claim 11, wherein the attachment portion comprises a rotational attachment component.

13. The apparatus of claim 12, wherein the rotational attachment component comprises a quarter turn rotational attachment component.

14. The apparatus of claim 12, wherein the rotational attachment component comprises:
a rotational attachment surface; and
an eighth turn rotational attachment component coupled to the rotational attachment surface.

15. The apparatus of claim 11, wherein the attachment portion comprises one or more of a slidable attachment component, threaded attachment component, locking attachment component, and tabbed attachment component.

16. The apparatus of claim 11, further comprising an engagement component adapted to proportionally adjust the degree of frictional engagement between the engagement surface and the cylindrical component of the bicycle.

17. The apparatus of claim 11, wherein the engagement portion includes a threaded portion.

18. The apparatus of claim 11, further comprising a threaded insert coupled to the engagement portion.

19. The apparatus of claim 11, wherein an attachment surface of the attachment portion is on a plane that is substantially tangentially aligned with the cylindrical component of the bicycle.

20. The apparatus of claim 11, wherein the engagement portion, attachment portion, and support portion consist of a unitary component.

21. A rotational attachment component of an accessory mount for positioning an accessory on a bicycle, comprising:
a support portion, wherein the support portion comprises:
a coupling portion configured to couple the support portion to the accessory mount; and
a plurality of extension portions that extend from the coupling portion; and
a plurality of ridges located on the extension portions and configured to fixedly attach the accessory to the accessory mount.

22. The apparatus of claim 21, wherein the plurality of extension portions comprises four extension portions and the plurality of ridges comprises four ridges.

23. The apparatus of claim 22, wherein each of the plurality of ridges is located on a respective one the plurality of extension portions.

24. The apparatus of claim 21, further comprising a fastening portion coupled to the coupling portion and configured to fasten the rotational attachment component to the accessory mount.

25. The apparatus of claim 24, wherein the fastening portion is located on an opposite surface of the support portion from the plurality of ridges.
